(19) United States
(12) Patent Application Publication
(10) Pub. No.: US 2020/0135068 A1
(43) Pub. Date: Apr. 30, 2020

(54) Wireless Rotatable Flagpole Assembly

(71) Applicant: Mitchell Moreno, Houston, TX (US)

(72) Inventor: Mitchell Moreno, Houston, TX (US)

(21) Appl. No.: 16/661,474

(22) Filed: Oct. 23, 2019

Related U.S. Application Data
(60) Provisional application No. 62/753,236, filed on Oct. 31, 2018.

(51) Int. Cl. G09F 17/00

(52) U.S. Cl. CPC G09F 17/0091; G09F 2017/0008

(57) ABSTRACT

A wireless rotatable flagpole assembly. The device includes a flagpole mount that includes a fastener adapted to secure the mount to a wall surface. A motor is disposed on the proximal end of the mount and is operably connected to a wireless transceiver, whereby the motor powers a rotating receiver. The motor and wireless transceiver are powered via a battery, which may be recharged via a solar panel. A flagpole is securable to the rotating receiver. A remote can be utilized to independently control multiple flagpole assemblies. The device allows users to rotate a flagpole in order to unfurl and straighten a flag that has become furled or otherwise misaligned due to high winds or other external forces.

### CROSS REFERENCE TO RELATED APPLICATIONS

This application claims the benefit of U.S. Provisional Application No. 62/753,236 filed on Oct. 31, 2018. The above identified patent application is herein incorporated by reference in its entirety to provide continuity of disclosure.

### BACKGROUND OF THE INVENTION

The present invention relates to flagpole stands. More specifically, the present invention relates to electronically rotatable flagpole stand assemblies.

Flags may frequently furl and get wrapped around a flagpole, especially during windy weather conditions. The flag must be unfurled manually, a difficult task for elderly individuals or those with physical limitations. This can also be an inconvenient task to have to be undertaken in inclement weather. Some individuals may need to climb a ladder in order to unfurl their flag and risk falling off the ladder, which can lead to serious injuries. People may be forced to spend a considerable amount of time unfurling their flags. Accordingly, a device that is configured to rotate to unfurl a flag is desired.

Devices have been disclosed in the known art that relate to flagpole mounts that include a fastener adapted to secure the mount to a building. These include devices that have been patented and published in patent application publications. These devices include a flagpole rotation device comprised of an upper collar having a rotator portion having two U-shaped portions adapted for securement around a flag pole. Another device includes an apparatus for use on a flagpole with a central elongated pole adapted for automatically unfurling and maintaining in an unfurled state a flag attached thereto. These devices, however, fail to disclose a wireless rotatable flagpole assembly including a motor operably connected to a rotating flag pole mount, wherein the actuation of the motor and direction of the rotation of the is controlled via a wireless remote.

In light of the devices disclosed in the prior art, it is submitted that the present invention substantially diverges in design elements from the known art and consequently it is clear that there is a need in the art for an improved rotatable flagpole assembly. In this regard, the instant invention substantially fulfills these needs.

### SUMMARY OF THE INVENTION

In view of the foregoing disadvantages inherent in the known types of flagpole assemblies now present in the known art, the present invention provides a wirelessly rotatable flagpole assembly wherein the same can be utilized for providing convenience for the user when selectively unfurling a flag from around a pole in a direction of the user's choosing via a wireless transceiver.

It is therefore an object of the present invention to provide a new and improved rotatable flagpole assembly that has all of the advantages of the known art and none of the disadvantages. The present system comprises an enclosed base adapted to be affixed to a surface having a flagpole mount extending outwardly from a front surface thereof, a motor disposed inside the interior volume is operably attached to a power source and configured to rotate the flagpole mount via wireless communication between a transceiver and handheld remote.

It is another object of the present invention to provide a wireless rotatable flagpole assembly wherein the flagpole mount disposed on the front surface of the enclosed base comprises a tubular cavity having retractable inserts within which are configured to adaptively receive and removably secure flagpoles of varying diameters therein.

Another object of the present invention is to provide a wireless rotatable flagpole assembly wherein the back side of the enclosed base has a concaved shape and apertures through the front and back surfaces of the enclosed base therethrough to receive fasteners and affix to rounded surfaces such as posts and trees.

Yet another object of the present invention is to provide a wireless rotatable flagpole assembly wherein the handheld remote is configured to wirelessly control the rotation of the mount in both a clockwise and counter-clockwise manner as decided by the user such that a flag may be unfurled regardless of the direction in which it has been furled.

Another object of the present invention is to provide a wireless rotatable flagpole assembly wherein the power source disposed within the enclosed base is rechargeable and operably connected to a solar panel disposed on the outer surface of the front face of the base.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the wireless rotatable flagpole assembly.

FIG. 2 shows a perspective view of an embodiment of the wireless rotatable flagpole assembly showing solar panel.

FIG. 3 shows a perspective half section view of an embodiment of the wireless rotatable flagpole assembly.

FIG. 4 shows a schematic view of the electronic components of an embodiment of the wireless rotatable flagpole assembly.

FIG. 5 shows a perspective view of an embodiment of the wireless rotatable flagpole assembly showing actuator.

FIG. 6 shows a perspective view of an embodiment of the wireless rotatable flagpole assembly with flag installed.

### DETAILED DESCRIPTION OF THE INVENTION

Reference is made herein to the attached drawings. Like reference numerals are used throughout the drawings to depict like or similar elements of the wireless rotatable flagpole assembly. For the purposes of presenting a brief and clear description of the present invention, the preferred embodiment will be discussed as used for wirelessly unfurling a flag from around a flagpole via a wireless transceiver in a direction of the user's choosing. The figures are intended for representative purposes only and should not be considered to be limiting in any respect.

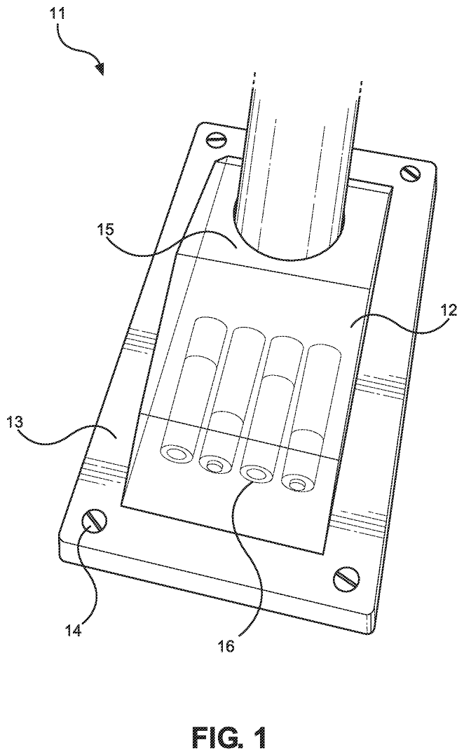

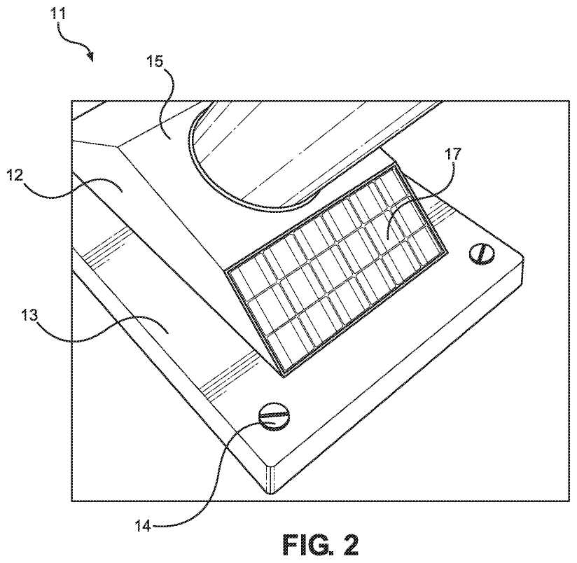

Referring now to FIGS. 1 and 2, there is shown a perspective view of an embodiment of the wireless rotatable flagpole assembly and a perspective view of an embodiment of the wireless rotatable flagpole assembly showing the solar panel, respectively. The wireless rotatable flagpole assembly 11 comprises an enclosed base 12 having a front side and a backside and a plurality of sidewalls thereon defining an interior volume. The back side of the enclosed base 12 being of a planar construction suitable for mounting the base 12 on a flat surface. A planar flange 13 extends orthogonally from each of the plurality of sidewalls of the enclosed base 12 and rests flush with the back side of the base 12. In this way, the planar flange 13 can flush against a mounting surface. A plurality of apertures 14 in the planar flange 13 are configured to receive fasteners, such as screws or nails, therethrough, such that the planar flange 13 can removably secure the wireless rotatable flagpole assembly 11 to the mounting surface.

A mount 15 extends outwardly from the front side of the enclosed base 12. In the illustrated embodiment, the mount 15 comprises a tubular cavity adapted to receive and removably secure a flagpole therein. The flagpole is removably securable within the tubular cavity via friction fit or any other suitable fastening means. A motor is disposed within the interior cavity of the enclosed base 12 and operably attached to a power source 16. In the illustrated embodiment, a solar panel 17 is disposed on an exterior surface of the front side of the enclosed base 12 and operably connected to the power source 16. The motor is attached to the mount 15 and configured to rotatably spin the tubular cavity along its longitudinal axis.

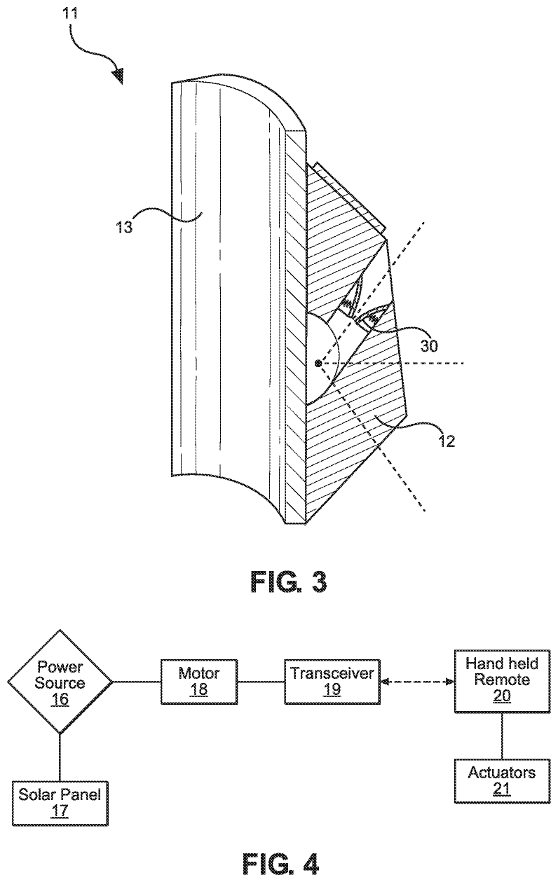

Referring now to FIG. 3, there is shown a perspective half section view of an embodiment of the wireless rotatable flagpole assembly. In alternate embodiments of the wireless rotatable flagpole assembly 11, the back side of the enclosed base 12 and flange 13 includes a concave shape adapted to rest flush with and conform to a curved surface, such as a post or tree. In some embodiments, retractable spring-based clamping members 30 disposed within the tubular cavity are configured to adaptively conform to the diameter of a flagpole removably secured within the tubular cavity, thereby allowing the user to install flags having poles of varying diameters. As a flagpole is received within the tubular cavity, the clamping members 30 will retract inwards to accommodate the diameter of the pole. The clamping members 30 are spring-biased against retraction and therefor allow for the flagpole to be removably securable within the tubular cavity via friction fit.

Referring now to FIG. 4, there is shown a schematic view of an embodiment of the wireless rotatable flagpole assembly. The motor 18 disposed within the interior volume of the enclosed base is operably connected to, and powered by, a power source 16 also disposed within the interior volume. In some embodiments, the power source 16 may comprise disposable batteries. In other embodiments, the power source 16 may comprise a rechargeable battery. Solar panels 17 disposed on an exterior surface of the front side provide a mechanism for recharging depleted rechargeable batteries. A transceiver 19 is operably attached to the motor 18 and in wireless communication with a handheld remote 20. The handheld remote 20 controls the motor 18 disposed within the interior volume via signals sent from the remote 20 to the transceiver 19 connected to the motor 18. In some embodiments, actuators 21 disposed on the handheld remote 20 allow the user to selectively control the rotation of the motor 18. In the illustrated embodiment, separate actuators 21 disposed on the handheld remote 20 control the clockwise and counter-clockwise rotations independently of one another.

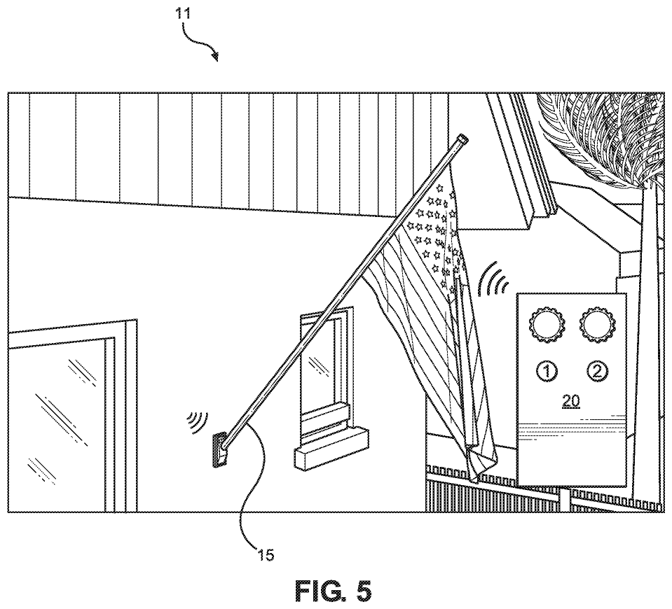

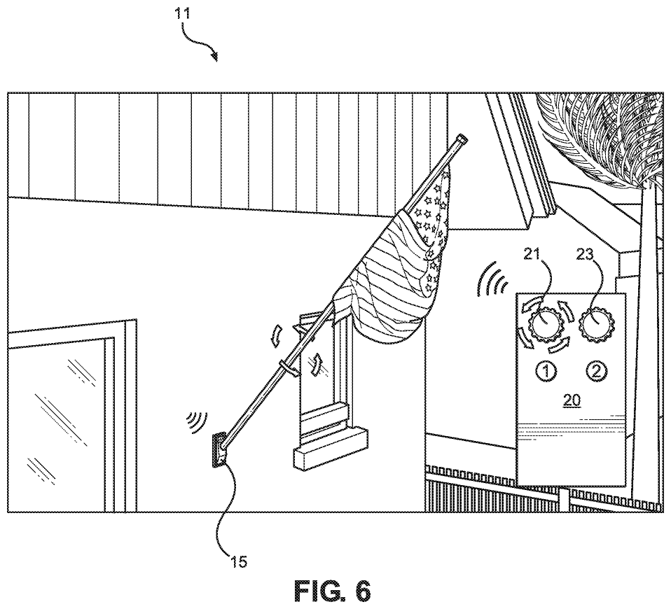

Referring now to FIGS. 5 and 6, there is shown a perspective view of an embodiment of the wireless rotatable flagpole assembly showing an actuator and a perspective view of an embodiment of the wireless rotatable flagpole assembly with flag installed, respectively. In the illustrated embodiment, the handheld remote includes a first actuator 21 that allows the user control the direction of rotation of a first mount, and a second actuator 23 that allows the user to control the direction of rotation of a second mount, via independent electronic signals from the handheld remote 20 to the transceiver. The actuators 21, 23 control the direction of the motor's rotation depending on the direction the dial is turned. In alternate embodiments of the wireless rotatable flagpole assembly 11, the handheld remote 20 can include a single actuator 21, and may ultimately include any number of independent actuators for independently controlling a desired number of mounts 15.

In the illustrated embodiment of the wireless rotatable flagpole mount assembly 11, the mount 15 is positioned at a 45-degree angle relative to the top of the surface to which the device 11 is affixed. In other embodiments, the mount 15 may be selectively positioned at angles corresponding to 45-degrees, 90-degrees, and 135-degrees relative to the affixed surface. This may be achieved by having the mount 15 pivotally attached to the enclosed base along a semi-circular rail having a ball-detent joint with fixed positions at the designated angles to allow a user to select the angle they wish. Having different selectable angles also allows a user a wider range of options for choosing where to affix the wireless rotatable flagpole mount assembly 11.

In practice, a user secures one or more of the devices 11 to a wall or structure surface at an angle of their choosing. If a particular flag becomes furled around the flagpole due to wind or inclement weather, the user may unfurl the flag from the comfort of their house using the one of the actuators 21, 23 to control the direction in which the motor for the corresponding mount 15 will rotate. Rotation of one of the dials causes the corresponding motor to rotate the respective mount 15 in a clockwise or counterclockwise direction until the flag completely unfurls and the user releases the respective actuator 21, 23.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless rotatable flagpole assembly, comprising:
an enclosed base having a back side and a front side and a plurality of sidewalk defining an interior volume wherein the front side is of a planar construction adapted to rest flush against a wall surface;
a mount extending outwardly from the front side of the base;
a motor operably connected to a power source and configured to rotatably turn the mount;
a transceiver disposed within the interior volume of the base and operably connected to motor;
a handheld remote in electronic communication with the transceiver and configured to wirelessly operate the motor.

2) The wireless rotatable flagpole assembly of claim 1, wherein the mount comprises a tubular cavity adapted to receive and removably secure a flagpole therein.

3) The wireless rotatable flagpole assembly of claim 2, wherein retractable clamping members within the interior of the tubular cavity are configured to adapt to, and removably secure, the diameter of the flagpole installed within the tubular cavity.

4) The wireless rotatable flagpole assembly of claim 3, wherein the retractable clamping members are spring-based.

5) The wireless rotatable flagpole assembly of claim 1, wherein apertures disposed through the front and back sides of the enclosed base are adapted to receive fasteners therethrough.

6) The wireless rotatable flagpole assembly of claim 1, wherein the back side of the enclosed base forms a concaved shape adapted conform to the rounded surface such as a post or tree.

7) The wireless rotatable flagpole assembly of claim 1, wherein the handheld remote includes at least one actuator configured to operate the motor disposed within the interior volume of the mount.

8) The wireless rotatable flagpole assembly of claim 7, wherein the at least one actuator comprises a first actuator configured to operate a first motor of a first mount and a second actuator configured to operate a second motor of a second mount.

9) The wireless rotatable flagpole assembly of claim 7, wherein rotation of the at least one actuator in a clockwise direction is configured to cause the motor to rotate in a clockwise direction, and wherein rotation of the at least one actuator in a counterclockwise direction is configured to cause the motor to rotate in a counterclockwise direction.

10) The wireless rotatable flagpole assembly of claim 1, wherein the power source is a rechargeable battery.

11) The wireless rotatable flagpole assembly of claim 1, wherein a solar panel disposed on the exterior surface of the front side of the enclosed base is operably connected to the power source.

12) The wireless rotatable flagpole assembly of claim 1, wherein the mount is adjustable along a pivot point of the front side of the enclosed base.

13) The wireless rotatable flagpole assembly of claim 12, wherein the mount is configured to selectively affix at angles corresponding to 45-degrees, 90-degrees, and 135-degrees relative to the back side of the enclosed base.

14) The wireless rotatable flagpole assembly of claim 1, wherein the power source is comprised of disposable batteries.
